(19) United States
(12) Patent Application Publication
(10) Pub. No.: US 2003/0233374 A1
(43) Pub. Date: Dec. 18, 2003

(54) Dynamic workflow process

(76) Inventors: Ulrich Spinola, Weinheim (DE); Andreas Engel, Weinheim (DE); Christian Bach, Nalbach (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/309,322

(22) Filed: Dec. 2, 2002

Related U.S. Application Data
(60) Provisional application No. 60/364,970, filed on Mar. 14, 2002.

(51) Int. Cl. G06F 17/00

(52) U.S. Cl. 707/104.1

(57) ABSTRACT

A system for creating and altering a dynamic workflow process during runtime and executing the runtime-built or modified workflow so that users can make ad hoc custom workflows and change workflows on the fly in response to special requirements of a given situation. A graphical tree editor is employed for runtime manipulation of the process definition. Mutually recursive meta-processes interpret runtime-built procedures for branch and step workflow processing.

### CROSS-REFERENCE TO RELATED APPLICATIONS

This application is related to U.S. patent applications Ser. No. 60/364,970, filed Mar. 14, 2002, by Dirk Michael Schulz et al., entitled “Electronic Records Management,” Ser. No. 10/209,28, filed Jul. 30, 2002, by Norbert Schroeder, entitled “Service Provider Integration Framework” and Ser. No. 10/210,860, filed Jul. 31, 2002, by Dirk Michael Schulze et al., entitled “Electronic Records Management,” each of which in its entirety is incorporated herein by reference.

### TECHNICAL FIELD

This invention relates to the field of electronic business records management, and more particularly to workflow processes involving the specification and execution of process routes for such records.

### BACKGROUND

One of the emergent capabilities of electronic business record management systems is to carry out predefined workflow processes, whereby records or elements of records, are automatically routed within a business organization for various actions by personnel or departments. This is an ideal setup when one action depends on another preceding action having already taken place. For example, draft purchase orders or check requests might be routed for editing, approval, printing, etc., through a prescribed natural order or sequence of actions by different personnel, each having specifically designated role for carrying out corresponding actions with respect to the particular type of record being passed along in the work stream.

The basic infrastructure for one type of workflow system is already offered, for example, in Records Management software available in R/3 from SAP AG of Walldorf, Germany. Workflow design involves associating a prescribed workflow with elements of a record so that when the element is displayed in the context of the workflow procedure, for example, in a workflow inbox, buttons or other action icons are presented which specify and, when actuated, trigger the recording and execution of the required action for a particular step in the workflow, and, immediately following completion of the prescribed action, automatically forward the record to the next node along the workflow process route. In addition, the prior workflow system recorded the progress of the workflow in a database as an associated record so that the status or completion of the workflow course can be observed or checked, for example, to establish what the prescribed procedure was, that it was followed, when it was completed, and so on.

Existing workflow process systems are premised on a pre-defined workflow definition created by an administrator so that at runtime the workflow that is executed, of course, is the prescribed workflow for that particular record or element. This insures that a desired course of action established by management is strictly adhered to.

### SUMMARY

The invention provides a way for users to create and change a workflow during runtime in response to the special requirements of a given situation and for the ad hoc workflow process definition to be executed and altered on the fly.

In one aspect the invention provides a framework in which workflow process can be created and changed during runtime by having users themselves insert, change or delete business process steps. The resulting dynamic workflow process is preferably designed to operate under the condition that the process may yield sequential and parallel ordering of steps and arbitrarily nested combinations of sequential and parallel steps or blocks of steps.

In another aspect, the invention comprises a dynamic electronic business process workflow method of creating during runtime an ad hoc workflow process definition consisting of sequential and parallel steps with associated record elements, actions and agents, and executing the ad hoc workflow process definition with a meta-process interpreter during runtime.

In another aspect, the invention comprises an electronic business process workflow method of providing, in a computer system for an enterprise, a class of pre-defined workflow processes that can be executed at runtime but are not alterable at runtime, and also providing on the same computer system for the same enterprise the capability of another class of dynamic workflow processes that can be created as a process definition at runtime, executed and altered at runtime by authorized users while the dynamic workflow process is undergoing execution.

A preferred embodiment of one aspect of the invention includes a workflow process which can be defined via a graphical user interface for allowing authorized users to create and alter during runtime a workflow process definition, and a meta-process for interpreting said definition during runtime to execute the corresponding workflow process.

The user interface preferably includes a graphical tree representing the workflow process in which nodes correspond to respective process steps in the process route. Preferably a block of parallel branches of steps is “announced” by a dummy node or pseudo step designating the subsequent steps as a parallel block.

The preferred workflow definition method includes for a collection of process steps connected in a process route, associating with each step an action and an agent for performing the action; and defining a process route for said collection of steps by specifying for each step,

a consecutive step ID;

whether the step is a sequential or parallel step; and

the parent of the step, where, in the case that the step is within a parallel branch, but not the first step in this branch, the parent is the beginning step of said branch.

The meta-process for interpreting and executing the workflow definition preferably includes mutually recursive branch and step workflow procedures. The branch procedure finds out if there are more steps to be processed in the same branch and calls the step workflow procedure; and the step workflow procedure executes the user activity associated with respective steps and finds out if there is a sub-branch to be started whereupon the branch procedure is called.

The underlying concept of the dynamic workflow process can be used anywhere a dynamic process is to be performed in conjunction with a process engine that reads the process definition. The practical relevance of the dynamic workflow process can be found, for example, in administrative processes that are not strictly routine, but instead are either new and different in some way or likely to undergo change at some point during the course of the running of the process.

By enabling runtime changes to subsequent steps along the process route, the dynamic workflow process empowers ordinary end users of records management systems by giving them an unprecedented degree of control over the workflow process via a straightforward, user-friendly interface. While often routine, many everyday tasks encounter exceptions that require different responses, for example, dispute resolution such as customer complaints, production processes especially in the service sector that do not have a predefined and fixed sequence of steps. The ad hoc functionality of the dynamic workflow process enables the user to react flexibly to changes as well as new requirements and nonroutine situations by defining a new process route or changing the process route on the fly. With real-time-enabled tools, a pre-specified process can be changed at any time, and by any authorized end user by means of a consistent intuitive interface, the results of which can be immediately implemented and processed during runtime without the intervention of an information technology (IT) administrator.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an overview block diagram of the possible contents of a record in a records management system.

FIG. 2A is a flow chart of a workflow process having serial and parallel steps.

FIG. 2B is a table showing the formal definition of the workflow shown in FIG. 2.

FIG. 2C is a screen shot showing a graphical tree representation of the workflow represented in FIGS. 2A and 2B.

FIG. 3A is a flow chart of a workflow process having two consecutive parallel blocks.

FIG. 3B is a table showing the formal definition of the workflow shown in FIG. 3A.

FIG. 3C is a graphical tree representation of the workflow represented in FIGS. 3A and 3B.

FIG. 4A is a flow chart of a workflow process having a parallel block within a parallel block.

FIG. 4B is a table showing the formal definition of the workflow shown in FIG. 4A.

FIG. 4C is a screen shot showing a graphical tree representation of the workflow represented in FIGS. 4A and 4B.

FIG. 5A is a flow chart of a workflow process having a block with two branches each with multiple steps.

FIG. 5B is a table showing the formal definition of the workflow shown in FIG. 5A.

FIG. 5C is a screen shot of a user interface in which the graphical tree representation of the workflow represented in FIGS. 5A and 5B has been created.

FIG. 6 is a screen shot of a create/change circular called “disposition” in this example.

FIG. 7 is a screen shot of the Process Route Definition screen.

FIG. 8 is a screen shot of a typical Business Workplace screen showing a workflow inbox with an item corresponding to a dynamic workflow created in the process route definition screen of FIG. 7.

FIG. 9 is a screen shot of a circular screen with an activity prescribed for the agent whose inbox is shown in FIG. 8 according to the workflow defined in FIG. 7.

FIG. 10 is a screen shot of the circular after all agents have executed their steps as prescribed by the workflow process defined in FIG. 7.

FIG. 11 is a composite flow chart of the meta-processes for branch and step workflow procedures to execute a dynamic workflow of the type shown for example in FIG. 5C.

### Like reference symbols in the various drawings indicate like elements.

### DETAILED DESCRIPTION

The following description is of a preferred embodiment of the dynamic workflow process in the context of a records management system, for example, the SAP Records Management system. The basic functionality of the dynamic workflow process described below has recently become available in SAP Records Management Release 6.20 and higher. The user documentation for this software is incorporated herein by reference, namely Online Documentation for SAP Records Management Release 2.00, an element of the mySAP Technology solution.

Records

By way of background, records are used to group together related information required for a business process or task. The individual items of information in a given record are called elements. Whole records, as well as elements within a record, can be regarded as elements.

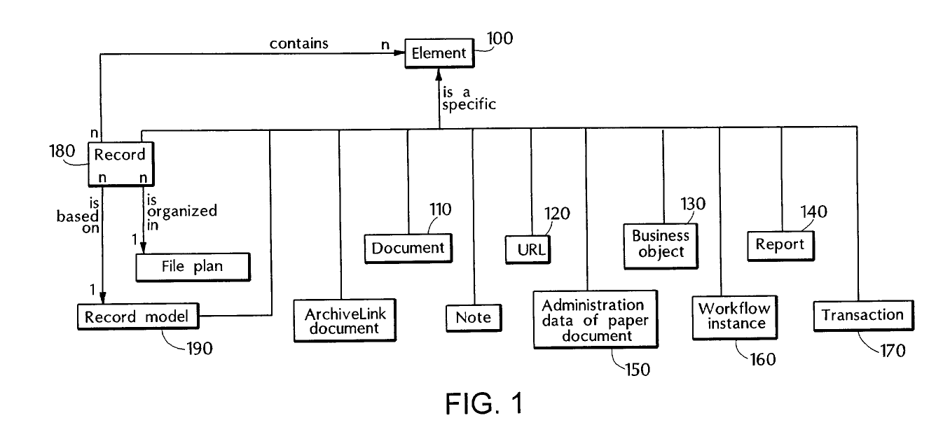

As shown in FIG. 1, record elements 100 can be of any type, including documents 110, URLs 120, business objects 130, reports 140, administration data for paper documents 150, workflows (the subject of the present application) 160, transactions 170, and even whole records.

Workflows

Business processes can be modeled as a workflow process having a beginning and an end, the end often corresponding to a decision, e.g., an approval or issuance of a purchase order. In between the beginning and the end, the workflow implements internal procedural requirements and external rules, if applicable, by carrying out a series of actions with respect to certain resource materials, e.g., elements of a record. Internal procedures within the organization assign various tasks involved in the business process according to a division of labor and responsibility, thus regulating how the process is executed.

Workflow Steps

Business processes such as vehicle location and allocation, reservation planning, order processing, production, order tracking, and shipment tracking can be managed using a workflow comprised of a series of steps involving actions and agents. Each step specifies a particular action or task to be carried out, e.g., with respect to an element of a record, and the agent, i.e., the individual or other entity to which each task is assigned. The path linking the series of agents defines a process route.

Workflows can also include time as a parameter. Thus, a workflow can be used to link the individual work steps of a process to a schedule, and specify not only which employees are responsible for which tasks, but also when the tasks should be done. At the appropriate time, the tasks can then be electronically delivered to the responsible parties.

Prior definition of the individual steps and the responsible parties, or agents, reduces the margin of error in comparison to paper-based processing. Implementing the workflow also helps ensures that none of the defined steps is omitted.

Workflows and Records

A workflow definition can be incorporated as an element in a record. The workflow can be started directly from the record. In this manner, workflows enable transaction processing from within a record. A workflow log can also be made available as part of the record. The workflow log lists the execution of the individual workflow steps and their processing times. In addition to the workflow log, all information objects affected by the workflow steps can be integrated into the record. As a result of long-term storage of the workflow log and the processed objects, the business process can be subsequently reconstructed and the process checked for errors, e.g., as part of an audit.

A record itself can be the object of a workflow, in that a workflow step can involve processing the record. If an employee executes the workflow step in his or her workflow inbox, the correct record is displayed for processing. This saves time when processing the record, and records can be easily processed based on the division of labor. Electronic records do not need to be physically transported, but can be “sent” as part of a workflow.

Overview of the Dynamic Workflow Process

In the past, workflows were pre-defined by professional IT administrators and were unalterable or static during runtime. In contrast, the workflow process of the present invention provides an interface and mechanism for dynamic workflow processes that are manipulated by end users of the system during runtime to make new workflows or custom alterations to dynamic workflows on an ad hoc basis. The dynamic workflow requires two new infrastructures: a user interface for users to build process definitions, and a meta-process to interpret and execute workflow processes defined at runtime.

The dynamic workflow process permits a user to attribute the property of a “circular” to a selected element of a record. The user can choose all the elements in a record for a circular, and create it as a complete version.

The user can define a process route or path definition for these elements. The process route is preferably based on SAP Business Workflow. The user models a process, and assigns an agent to each step. In addition to actual employees, the user can also enter other organizational categories or entities from a directory such as SAP Organizational Management. The user can create process route items sequentially, or in parallel. When satisfied with the dynamic workflow process definition he or she has created, the user saves the process route and it is immediately available.

For executing the assigned activity, the employees entered in the process route as agents receive a work item in their workflow inbox. When they execute the work item, a list is displayed containing all the elements selected by the creator of the circular. The agent can double click to display these elements. They can then use pushbuttons to execute the functions provided for the activity, and can also add attachments to the elements, just as with the old pre-defined workflow process. Once a work item, i.e., the user activity associated with a given step, has been executed, the employee in the next position or node along the process route receives a work item in his or her workflow inbox.

The specified process can be changed at any time. This ad hoc functionality enables the user to react flexibly to changes. Steps that have already been processed, of course, can no longer be changed.

User Interface

Graphical Tree Editor

In order to support the user in defining and changing such a dynamic workflow process, an easy-to-use graphical editor was implemented based on a graphical representation scheme for the generic workflow process.

Design of Process Description

The process description consists of three parts:

Head information, e.g., identifying the user who created the workflow

Description of the structure of the process, i.e., the path definition or process route

Step Information for each step of the process, i.e., the action, agent and optional timing.

Head Information

ID of the process

Name of the process

Creator, Creation date, creation time

Structure

The structure of the process is described in a way that is suitable for graphical representation in a tree structure. It is described in a table, where each row carries the following information:

1. Step id

Unique identifier of a step

2. Step id of parent step

A step is a parent step of other steps, if it is the first step of at least two steps in a parallel branch.

Consequently, a child step is a step that occurs in a parallel branch, but not as the first step of this branch.

3. Step type

The step type denotes whether a step is a sequential step or a parallel step. Parallel steps again are differentiated to be of type “beginning of parallel block”, “in parallel block” (not the beginning or end of the block but somewhere in the middle) and “end of parallel block”. A block comprises a set of branches that start together. Only the first steps in each branch get to be designated as “parallel steps.”

The sequence of the rows in the table carries topological significance.

Step Information

For each step, information like planned processor (i.e., agent); activity and optionally deadline or some other kind of information about the step is defined. In addition, during runtime a step holds the information if it has already been processed, by whom, at what time, etc.

Examples of Graphical Representation of Workflow

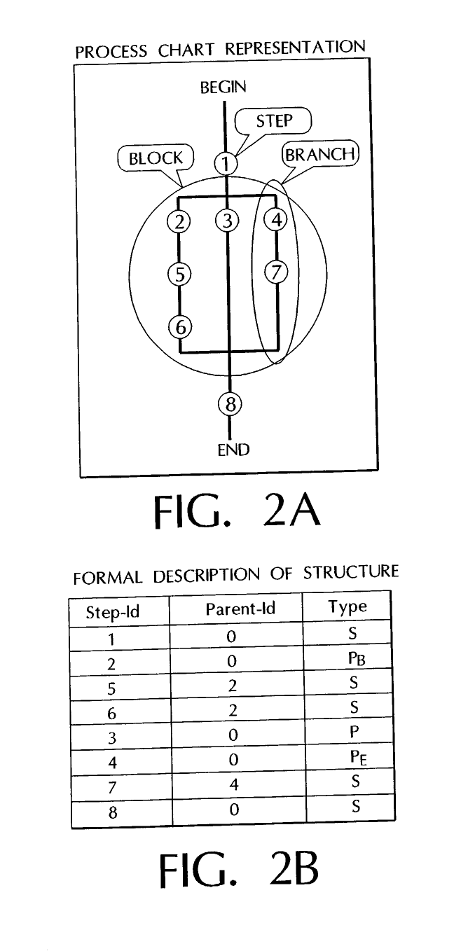

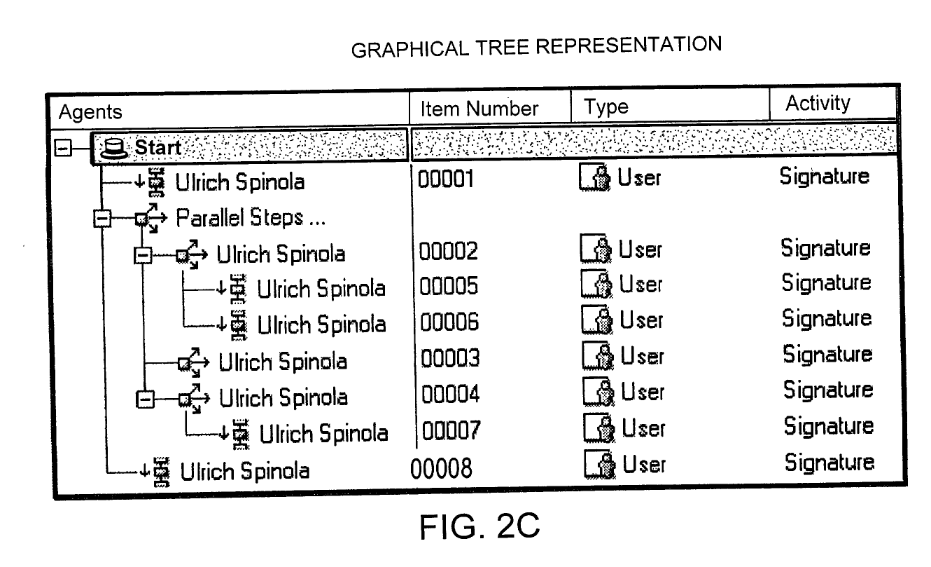

The process chart of FIG. 2A shows an example of a workflow with a single parallel block. The workflow has eight defined steps connected in a process path or route. A formal description of the structure of the workflow in FIG. 2 is given in the corresponding table of FIG. 2B, and a screen shot of a graphical tree representation which serves as the actual user interface for defining and displaying the resulting workflow is shown in FIG. 2C.

The workflow of FIG. 2A consists of a sequential step (step 1) followed by a parallel block consisting of three separate parallel branches (steps 2-7), followed by a sequential step 8. According to the step type definition, step 2 is a parallel step of the type “beginning of parallel block”. Step 3, the first step in the second branch, is a parallel step of the type “in parallel block”. Step 4 is not only the first step in the third branch; it also stands as the head of the last branch, so step 4 is a parallel step of the type “end of parallel block.”In the table of FIG. 2B, parallel steps 2, 3 and 4 are thus designated by the corresponding symbols P_{B}, P, and P_{E}, respectively. The first branch also contains sequential steps 5 and 6. The second branch contains no sequential steps. The third and last branch contains one sequential step 7. The numbering of the steps has no meaning for the sequence of the execution. The numbers are merely assigned by the program in the order in which the steps happen to be created when the user defines or changes the process. So step 8 could be at the beginning if the user inserts his 8^{th} th step at the beginning. Actually, the numbering is usually not important to the end user. It is just to have a unique identifier for each step. In addition, the order of parallel branches belonging to one block is not important: the branch with step 3 could be on the right hand side and the branch with steps 4 and 7 in the middle, for example, and the workflow would process in the same manner.

A step is presented, i.e., sent to the workflow inbox of the corresponding agent for the step, when all previous steps of the same branch in the workflow path have been executed. In the example of FIG. 2A, parallel steps 2, 3 and 4 are presented after step 1 is executed. Step 5 is presented after step 2 is executed, independent of the state of steps 3 and 4. Step 7 is presented after step 4 is executed. Step 8 is presented only when steps 6, 3 and 7 have all been executed, i.e. when the parallel branches are finished. Steps appearing on the same level in the flow chart (like 5 and 7) are not necessarily presented to the user simultaneously. If step 4 is completed before step 2, then step 7 will be presented before step 5, and so on.

The table representation (FIG. 2B) can best be understood by thinking of the graphical tree representation. We climb through the tree from the root to all branches always going to all sub-branches before continuing with the next branch. The order of the lines in the tree representation is the same as the order of the rows in the table representation.

The term branch level refers to the degree of ramification, i.e., the number of branchings or parallel steps you have to pass from the root level before you reach a step. In my examples steps 5, 6 and 7 are on branch level 1 (because to them the process path only traverses one parallel step: step 2 for steps 5 and 6 and step 4 for step 7. All other steps are on branch level 0 because the path to them does not traverse a parallel step.

In the graphical tree representation the indentation corresponds to the branch level.

The resulting graphical tree representation in FIG. 2C allows visualization of the structure and step information in one display. The screen is divided into columns for agents, item Number, type and Activity. Other columns may be added as desired to display other attributes of the steps. The display is laid out stepwise, but the order in which the steps are presented is embedded in the tree and node information. The tree itself is displayed in the Agents column and an agent is specified for each node of the process path. The nodes of the tree correspond to steps.

Note that a process chart of considerable complexity can be represented in a tree structure by use of just two types of icons for steps: sequential and parallel. However, in the preferred embodiment the kind of flow charts possible, however, is restricted for the sake of simplifying the interface to processes which yield only sequential and parallel ordering of steps and arbitrarily nested combinations of sequential and parallel steps or blocks of steps. This means that no loops (iterative routines), conditional processing (e.g., conditional branches) or other features of process definitions are supported. These more complicated logical constructs are possible in full-fledged business workflow editors used by IT administrators to make runtime workflows. The dynamic workflow, in contrast, is designed to encourage use by ordinary business users for whom training and maintaining the needed skill level would be problematic.

Each sequential step is represented in FIG. 2C by an icon having a down arrow and a process flow symbol. Each parallel step (remember there are only three types, beginning, ending and within block, each at the head of a branch) is represented by a box with three arrows vectored in different directions. If a parallel step has sub-steps in the same branch, the sub-steps are viewable via a standard expand/collapse button.

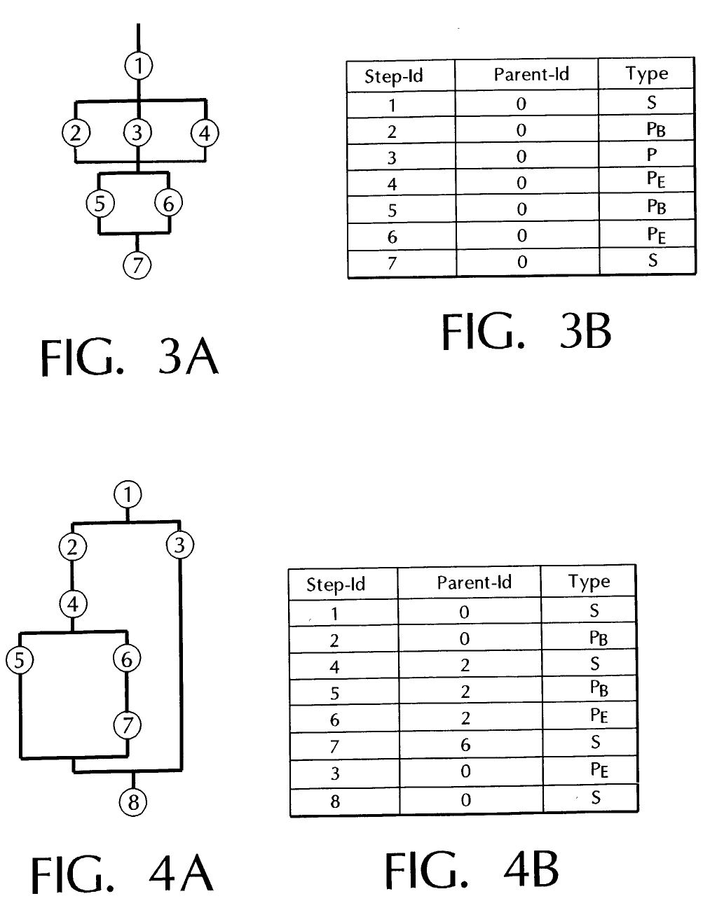

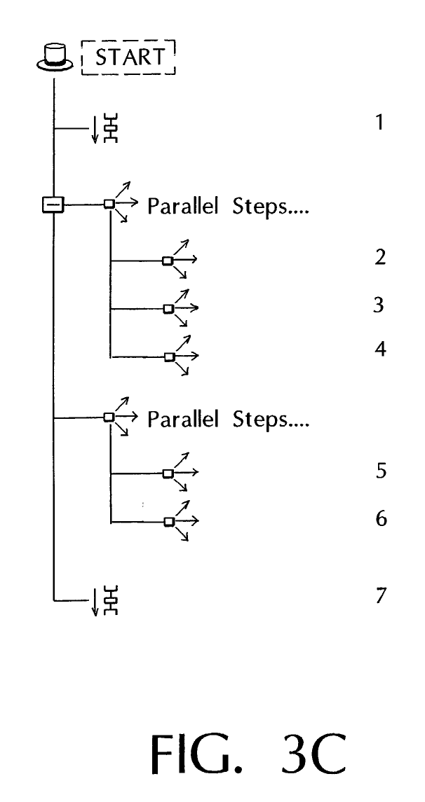

To designate the beginning of a parallel block, a special pseudo node “Parallel Steps . . . ” is introduced in the graphical editor by a “dummy” parallel step icon. Note that this line in the tree structure of FIG. 2C does not represent a step. Nor is it found in the table of FIG. 2B. It is only an “announcement” that there are parallel steps ahead. This announcement with an indentation of the following lines is needed to graphically represent a block of steps, which can be collapsed and expanded all together. The “pseudo step” is necessary as a placeholder for the entire block to be completed before going on to the next sequential step 8. If this “pseudo step” were not used, there would also be a problem that one could not tell whether the steps of two blocks following each other immediately belonged to the first or the second block. A flow path of this topology is shown in FIG. 3A, where a first block is followed by a second block with no intervening sequential steps. In addition, the branches are all singletons with no sequential steps. Accordingly in the corresponding table of FIG. 3B all of the parent-IDs are the same because of the lack of sequential steps in the branches. The corresponding graphical tree representation in FIG. 3C distinguishes the blocks well by using pseudo parallel steps to announce the blocks.

An alternative way to implement the graphical tree representation that would avoid the use of the pseudo parallel step to designate the beginning of a block would be to have three different icons for the three parallel step types (beginning, middle and end). Then in the tree of FIG. 3C, for example, steps 2 and 5 would be represented by a special beginning of parallel block icon and steps 4 and 6 by a special end of block icon. This iconography appears to be less intuitive however to the user than that shown in FIG. 3C, in which the pseudo step is used and the parallel steps are undifferentiated nodes. Of course, one parallel step will always be first and one will be last in the block presented visually to the user. So the relationship is implicit in the graphical tree representation.

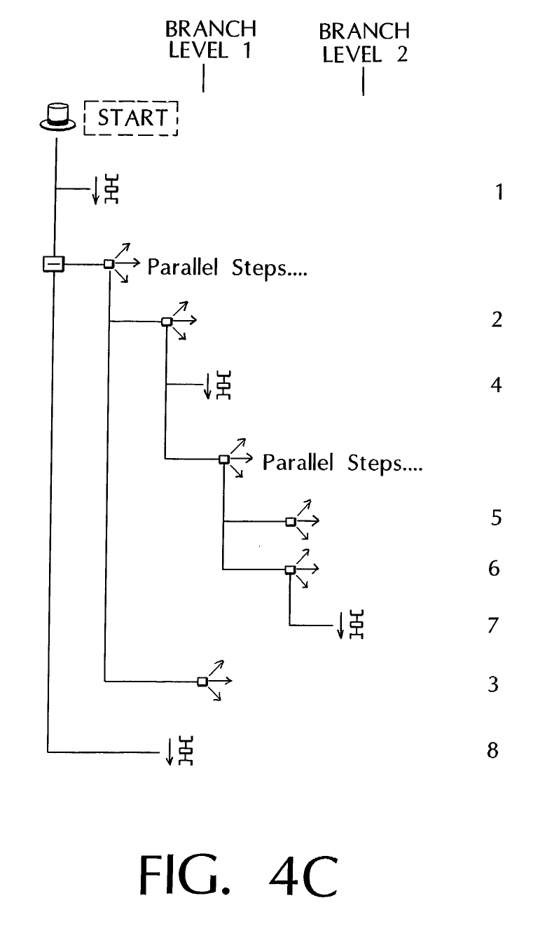

A flow chart for a block with nested parallel blocks is shown in FIG. 4A and its accompanying table FIG. 4B and graphical tree representation FIG. 4C. In this case the tree representation shows several indentations corresponding to successive branch levels 1 and 2. Step 7 is at branch level 2 because the process path to step 7 traverses two parallel steps 2 and 6.

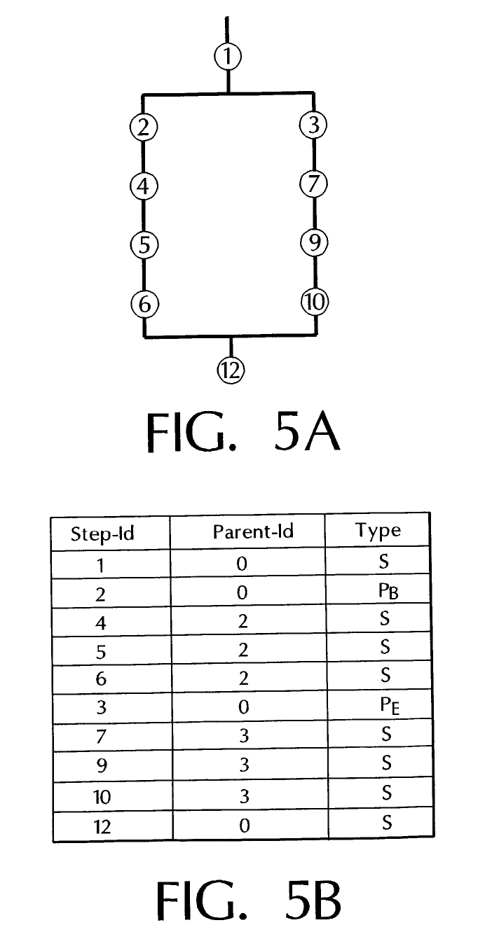

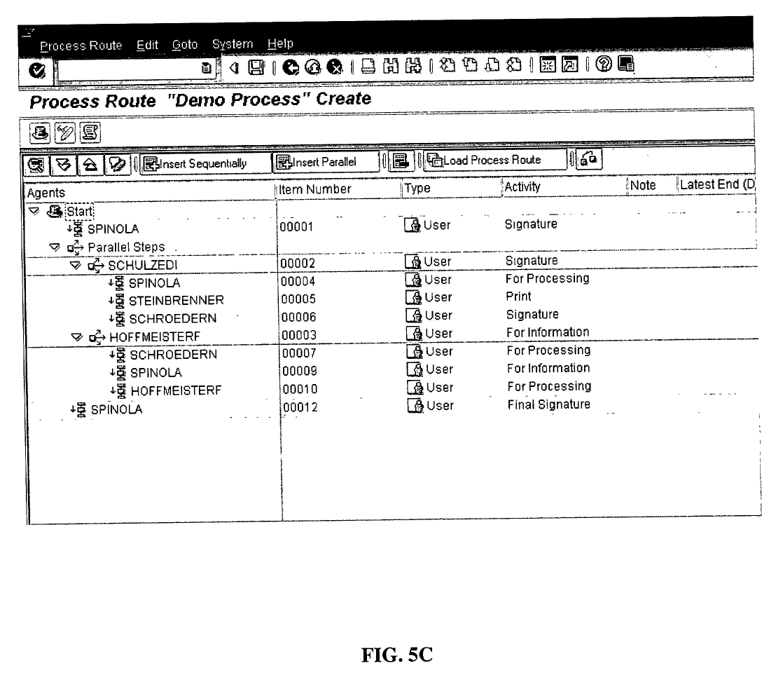

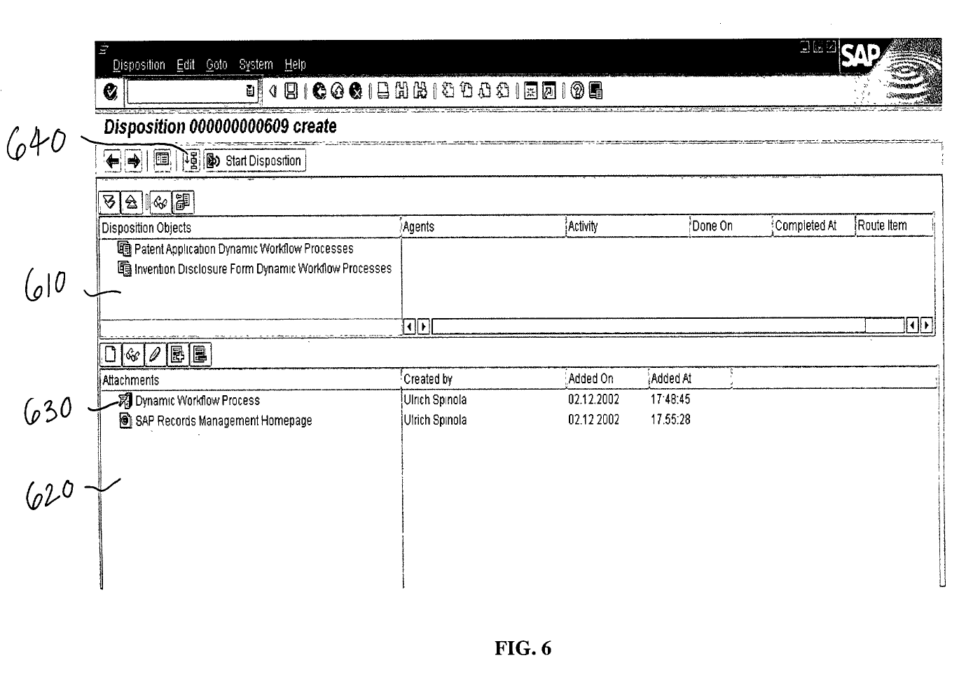

A flow chart for a block with many sequential steps in parallel branches of a block is shown in FIG. 5A and its accompanying table FIG. 5B. The corresponding graphical tree representation in FIG. 5C is a screen shot from the user interface screen called “Create Process Route” which has been used to create this particular dynamic workflow example. Instructions on how to use this screen are found below. This representation follows the same basic design but instead of the standard interconnected tree nodes, standalone triangular arrows are used. A down facing triangle means the sub steps are expanded. A right facing triangle means the sub steps are collapsed. In the menu bar an existing process route can be opened and edited or a new one created. By using the “Insert Sequentially” or “Insert Parallel” buttons, the user can add a sequential or parallel process step node at a point indicated by the user's cursor, as further explained below Nodes can be deleted by selecting and hitting delete. This example also illustrates how step numbers can wind up being skipped. Note that step numbers 8 and 11 are missing. These were steps that were deleted. The numbering of steps just continues.

User-Oriented Instructions for Developing Workflow Process Routes for Circulars

Below is an example of the user instructions for designing a custom workflow during runtime. These instructions are taken from the user documentation for SAP Records Management Release 6.20.

Use

You use a circular and a process route if you want to send individual elements from a record in sequence to more than one employee. You can determine which activity each employee will execute, (for example, approve, edit, print, and so on).

The term circular is a general term used to cover all documents sent in circulation, including in the public sector.

Integration

A circular can only be created from a record, and not directly from the Records Organizer.

Prerequisites

You have carried out the workflow basic Customizing. You have been authorized to create and/or alter dynamic workflow processes.

Features

You can choose all the elements in a record for a circular, and create it as a complete version.

You can define a process route for these elements. The process route is based on SAP Business Workflow. You model a process, and assign an agent to each step. In addition to actual employees, you can also enter other organizational categories from Organizational Management. You can create process route items sequentially, or in parallel.

For executing the assigned activity, the employees entered in the process route as agents receive a work item in their workflow inbox. When they execute the work item, a list is displayed containing all the elements selected by the creator of the circular. The agent can double click to display these elements. They can then use pushbuttons to execute the functions provided for the activity, and can also add attachments to the elements. Once a work item has been executed, the employee in the next position along the process route receives a work item.

The specified process can be changed at any time. This ad hoc functionality enables the user to react flexibly to changes (steps that have already been processed can, of course, no longer be changed).

Creating Circulars and Process Routes

1. In a record, place the cursor on a model node, to which an element type for circulars is assigned, open the context menu, and choose Create.

A dialog box is displayed that contains a list of all the elements of the record that already exist as a complete version. If more than one complete version exists for an element, the most recent version is listed in the first hierarchy level, and previous versions are listed in the second hierarchy level.

2. Use the checkbox to select the elements that you want to send in the circular, and then choose the check mark.

The Display Circular screen appears. An example of this screen, titled here “Disposition Create” is shown in FIG. 6. This is divided into two screen areas. The objects for the circular are displayed in the top screen area 610, in this example, a patent application and an invention disclosure. These are the elements that you selected in the previous step. Attachments are displayed in the bottom screen area 620. In the standard setting, the attachments include a link 630 to the whole record from which you have created the circular. Users can add any number of additional attachments.

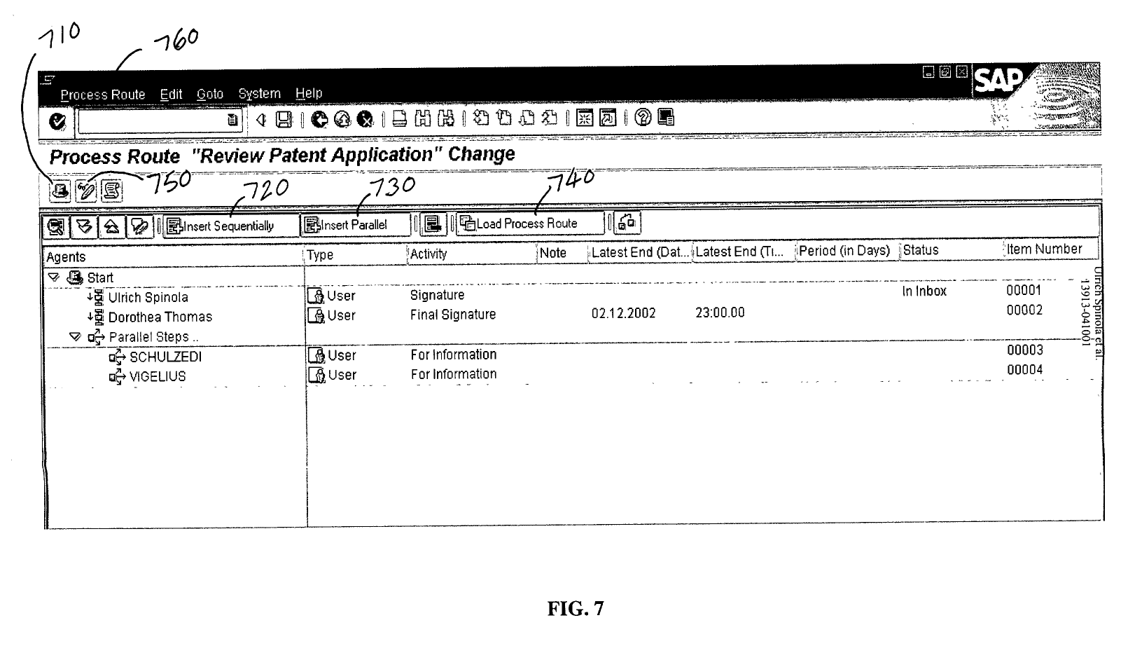

3. Choose the icon 640 for a sequential step, which automatically brings up the Process Route Definition screen either for creating a new process route or for changing an existing process route as in the case of FIG. 7. (See FIG. 5C for another example of this screen) In this screen, you can define the process route for the elements.

4. To maintain the header data for the process route, choose the hat icon 710.

5. Add process route items. You have the following options for adding process route items:

Add sequentially: The process route item is added after the item on which the cursor is currently placed. When the circular is executed, the work item is not sent until the agent processing the previous process route item has completed their work item.

Add in parallel: The process route item is added parallel to the item on which the cursor is currently positioned. When the circular is executed, both employees receive a work item at the same time.

If you select Insert Sequentially 720 or Insert in Parallel 730, a dialog box is displayed. In the upper screen area, the details are displayed for the preceding process route item, that is, the item on which your cursor is currently positioned. In the lower screen area, you can determine the properties of the new process route item.

Load process route template 740: You can load a process route that you have created previously, if you have saved that process route as a process route template.

If you choose Load Process Route Template, a search template is displayed in which you can restrict the search for existing process route templates. To start the search, choose the binoculars icon. To use a process route template, double click on it in the hit list.

6. Choose the check mark.

The new process route item or the selected process route template is displayed in an overview tree. If you have used a process route template, you can then make any required changes to it.

7. When you have added all the process route items, check the process route by clicking on a testing icon, which automatically checks the topology and completeness of the process route, and then save.

Note: You can save the process route you have created as a process route template, so that you can reuse it later. To do this, choose Process Route 760 → Load as Template. Assign the process route to a process route template group (process route template groups are used for improved user orientation, and are created in Customizing).

8. Choose the green arrow to navigate back to the circular.

9. Choose Start Process Route.

Result

The agent of the first process route item receives a work item in their workflow inbox. After the process route item has been processed, the next agent in the route receives a work item.

The model node for circulars in the record becomes an element for the circular. In the context menu, choose the activity Log for an overview of the status of the process you have started. The Display Process Route screen appears. Choose the printout paper icon to navigate to the log.

If all process route items have been completed, you receive a work item to notify you that the process has been completed.

Executing a Work Item for a Circular

Prerequisites

You are entered as an agent for a process item in a process route. The agent of the preceding process route item has executed and completed their work item.

Procedure

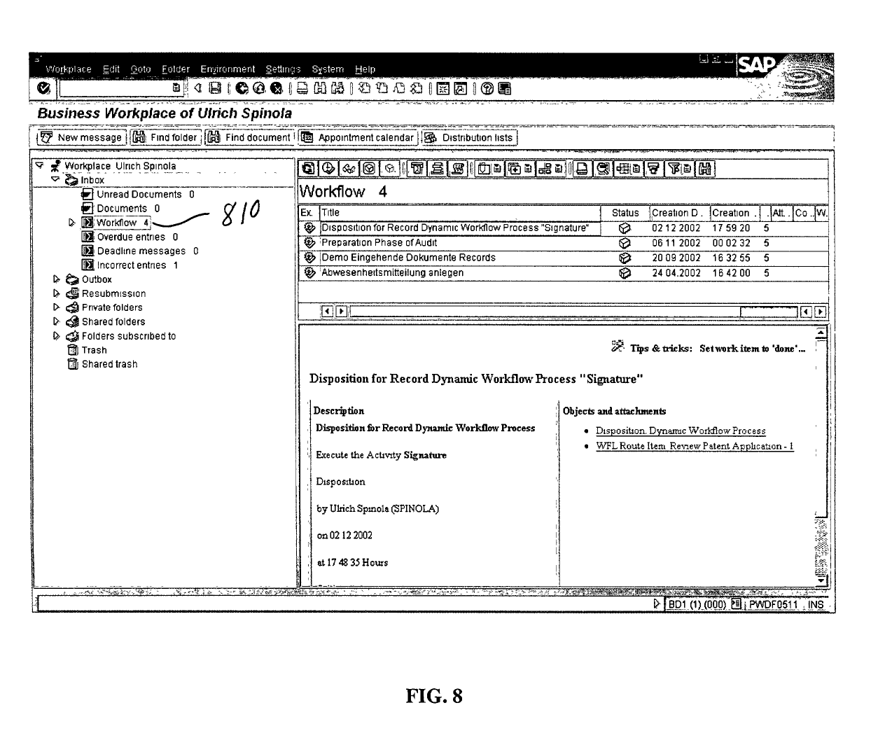

1. Open Business Workplace (transaction SBWP), as shown in FIG. 8, and choose Inbox→ Workflow 810.

You have a work item in your workflow inbox that contains the processing of a process route item. The text of the work item contains an option to link to the circular and the process route.

2. Execute the work item.

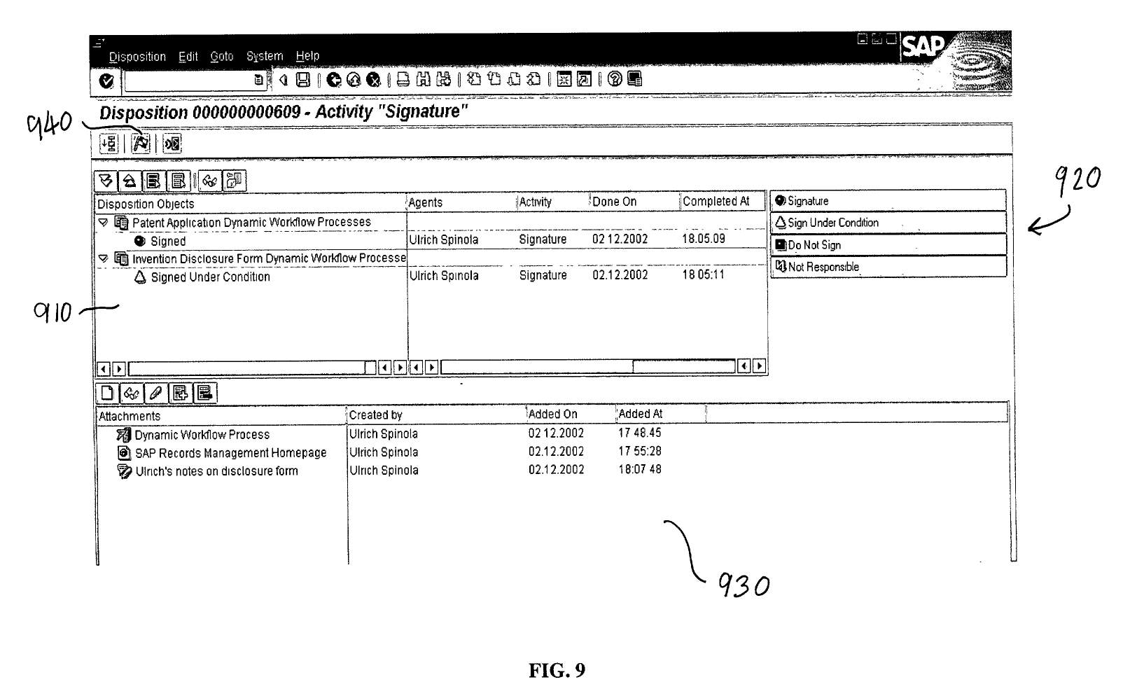

The Circular screen appears, as shown in FIG. 9. The screen is divided into two areas:

In the upper screen area 910, the elements for you to process are displayed. You can display the elements by double clicking on them. On the far right are the pushbuttons 920 with the activity functions.

The lower screen area 930 contains the attachments for the circular. In the standard setting, the link to the record from which the circular has been created is always included. You can double click to open the attachments.

3. Select an element and execute an activity function by choosing the appropriate pushbutton.

The activity function you have selected is displayed one hierarchy level below the element. If other agents have already processed the circular before you, your entry is added under the entries of your predecessors.

4. Execute an activity function for each element.

5. If necessary, create one or more attachments in the lower screen area.

To create a new element as an attachment, choose the paper with pins on the side icon. A dialog box is then displayed, in which you have to select an element type for the attachment. To create an element that already exists within Records Management as an attachment, choose the appropriate icon. The attachments are also visible for all subsequent agents who process the circular.

6. Choose the checkered flag icon 940 to Complete Circular Step.

The work item is completed. You are back in the Business Workplace. The user who is entered as the next agent for a process route item receives a work item.

Note: If you are the last agent in the process route, the additional pushbutton End Circular is available. Choose this button to state that the circular is complete (this replaces the checkered flag button).

The employee who started the circular can also end it using the End Circular button. This can be at any time, even if not all of the process route items have been completed.

If a process route has been ended, this is displayed in the header data of the process route, along with the name of the user who ended it.

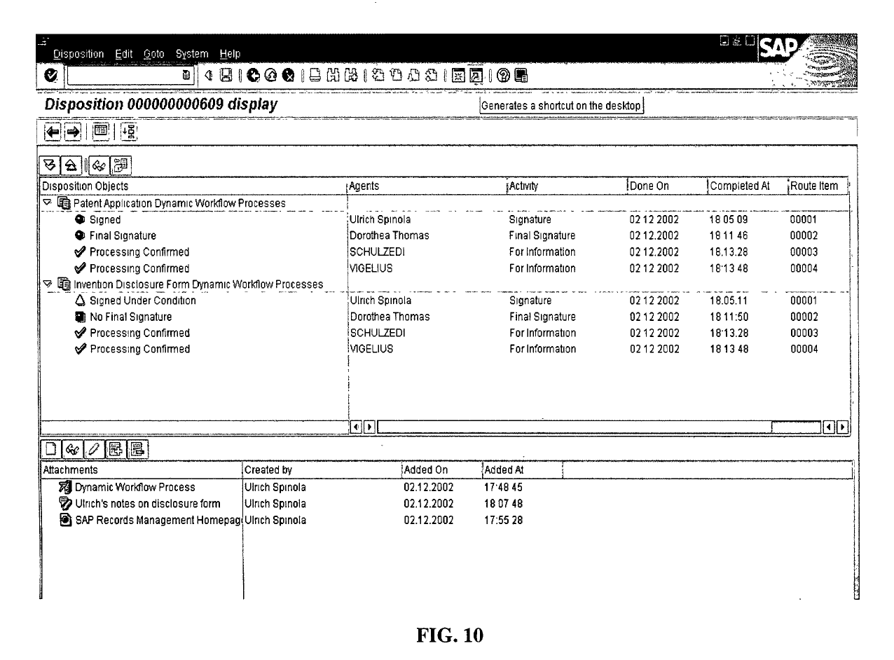

After all agents have executed their steps, the circular might appear as shown in FIG. 10, in which all of the agents and activities of each agent, completion date and time are displayed.

A Meta-Process for Dynamic Workflow Processes

Meta-Process for Execution of Runtime-Built Workflow Process

The requirement was to develop a technique to interpret and run a workflow process and change the process in an arbitrary way during runtime, i.e. insert, change or delete steps under the condition that the process may yield sequential and parallel ordering of steps and arbitrarily nested combinations of sequential and parallel steps or blocks of steps.

A step is specified by a user activity, an agent and—optionally—a deadline. Agents can be system users or organizational entities like jobs, positions and organizational units.

A generic meta-process definition was developed to allow the execution of any process with the characteristics described above.

Design of Meta-Process for Generic Process Execution

Two workflow process definitions are needed to execute the steps of the process in the right order:

One workflow (branch workflow) processes branches of the process. It basically consists of a loop; in each loop run one sequential step or a block of parallel steps is processed by calling the second workflow (step workflow), which contains the actual activity for the user. The step workflow itself calls the branch workflow recursively if the step is the start of a new branch. Both workflows contain steps for evaluation of the process description. In the branch workflow an evaluation is needed to find out if there are more steps to be processed in the same branch and to provide the step information (activity, agent, etc.) for execution of the these steps. In the step workflow an evaluation is used to find out, if there is a sub-branch to be started.

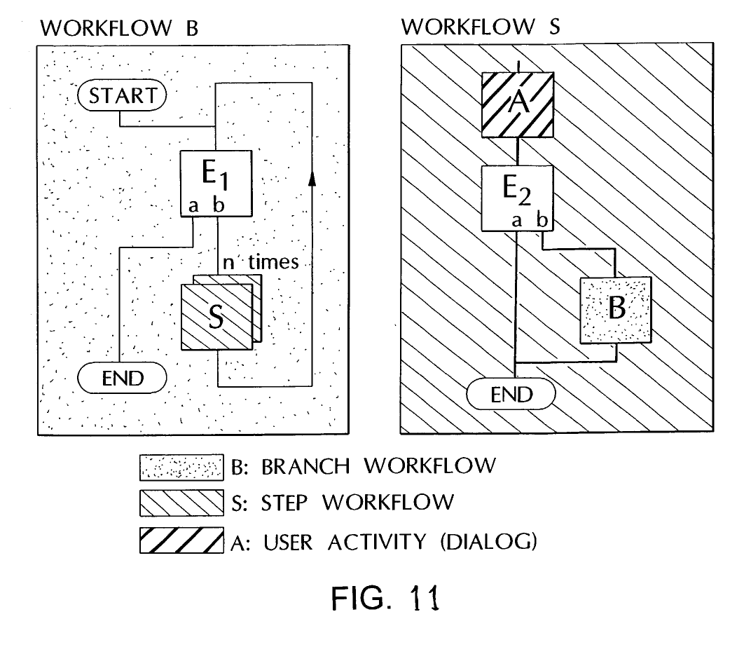

FIG. 11 illustrates the two workflows: the Branch Workflow and the Step Workflow. These procedures are mutually recursive; the Branch Workflow calls the Step Workflow and the Step Workflow can call the Branch Workflow. These two procedures represent a meta-process that interprets the ad hoc workflow process definition. The actual realization of the action in dialog with the agent, (i.e., send and present button to agent and wait for agent to react and record reaction), is carried out as the initial action in the Step Workflow designated A. B is a call to the Branch Workflow. S is a call to the Step Workflow. Evaluations E₁ and E₂ in FIG. 6 are implemented in accordance with the following pseudocode description:E₁: st Evaluation of path definition

a: no more steps on same branch level

=> return to calling branch level

b: there are more steps on same branch level

=> call step workflow S n times

(n= number of parallel steps to be processed)

E₂: 2nd Evaluation of path definition

a: step is not start of a new branch

=> return to calling branch workflow B

b: step is start of a new branch

=> recursive call of branch workflow B: User activity (dialog).

A new branch starts when a parallel step has one or more subsequent steps that are in the same parallel branch.

Environments Containing both Static and Dynamic Workflow Processes

Pre-defined or static workflow processes are created off-line by an IT administrator. Many business processes can be usefully run based on predefined workflows. For example, an approval of leave request could be defined as a process with two steps: Step 1: decision upon approval by superior; Step 2: notification of employee who submitted the request. The process will always run as defined. No steps can be added or deleted. The process definition cannot be changed during runtime. There is no need for user manipulation of the process. Indeed, in many cases, user manipulation of standard pre-defined business process would be detrimental.

On the other hand, there are other situations that call for new or changed business processes, for example, a document that needs to be reviewed by a number of persons. The author defines a new process including steps for every person to be involved (according to his opinion) and starts the process. During the process one person wants to include somebody else in this review process. The additional person can simply be added to the process at any point (which is not in the past).

The dynamic workflow process allows running the process based on a definition that can be changed during runtime. Usually this definition is created not by an administrator but by an end user who wants to start a process, e.g., an approval that involves a number of persons. Everybody who has the authority to change the process can insert or delete steps while the process is running. So if during the process person A thinks person B should also be involved in a certain approval process, A can just insert a new step assigned to B.

Ideally the enterprise has the capability to invoke both static pre-defined workflow processes and dynamic workflow processes created by a pre-authorized set of users as appropriate to the given business processes that the enterprise encounters. Thus, the fully outfitted enterprise would support two classes of workflow business processes: static and dynamic.

A number of embodiments of the invention have been described. Nevertheless, it will be understood that various modifications may be made without departing from the spirit and scope of the invention. For example, other Records Management systems may use different organization and nomenclature for records, and it is understood that the workflow process can operate on any “object” and stay within the scope of the invention. Other graphical representations of the process can also replace the illustrated graphical tree representation and iconography if desired. Accordingly, other embodiments are within the scope of the following claims.

What is claimed is:

1. An electronic data processing method for defining during runtime a workflow process consisting of a collection of process steps connected in a process route, comprising
associating with each step an action and an agent for performing the action; and
defining a process route for said collection of steps by specifying for each step,
a consecutive step ID;
whether the step is a sequential or parallel step; and
the parent of the step, where, in the case that the step is within a parallel branch, but not the first step in this branch, the parent is the beginning step of said branch.

2. The method of claim 1, wherein the step of specifying whether the step is sequential or parallel includes the limitation that a parallel step is defined as one of three types, (1) the beginning of a block of parallel steps, (2) the end of said block or (3) within the block but neither at the beginning nor the end.

3. The method of claim 1, further comprising, graphically representing the workflow process as a tree in which nodes correspond to respective process steps in the process route.

4. The method of claim 3, wherein a node preceding the beginning of a block of parallel branches of steps corresponds to the block as a whole.

5. The method of claim 4, wherein parallel steps of said three types are all represented by the same icon.

6. The method of claim 3, wherein each node of the tree representing a step has associated with it multiple fields displaying respectively at least the agent and the action associated with the step corresponding to the node.

7. A meta-process for interpreting and executing an ad hoc dynamic workflow process definition including process steps connected in a path definition sequentially and in blocks of parallel branches each with at least one step, with the possibility of a branch including as a step, a nested block of parallel branches, comprising
providing a branch workflow procedure to find out if there are more steps to be processed in the same branch; and
providing a step workflow procedure to execute the user activity associated with respective steps and to find out if there is a sub-branch to be started.

8. The method of claim 7 wherein said branch workflow procedure further includes calling the step workflow procedure to execute each parallel step.

9. The method of claim 8, wherein said branch workflow procedure includes a first evaluation of the path definition to determine if there are no more steps on the same branch level, in which case the process returns to the calling branch level, otherwise the process calls the step workflow iteratively for each of the parallel steps to be processed at said branch level.

10. The method of claim 9, wherein said step workflow includes a second evaluation of the path definition to determine if the step is not the start of a new branch, in which case the process returns to the calling branch workflow procedure, otherwise the process executes a recursive call of the branch workflow procedure.

11. A method of operating a computer system having a workflow process engine, comprising
creating a workflow process and changing the process during runtime by inserting, changing or deleting steps under the condition that the process may yield sequential and parallel ordering of steps and arbitrarily nested combinations of sequential and parallel steps or blocks of steps.

12. A dynamic electronic business process workflow method, comprising
creating during runtime an ad hoc workflow process definition consisting of sequential and parallel steps with associated record elements, actions and agents; and
executing the ad hoc workflow process definition with a meta-process interpreter during runtime.

13. The method of claim 12, wherein the step of creating the process definition includes presenting to an authorized user a graphical user interface for composing the workflow process definition.

14. The method of claim 13, wherein said graphical user interface comprises a tree representation of the process.

15. The method of claim 14, wherein said interface permits the user to insert parallel or sequential steps as nodes in the tree to define the process.

16. The method of claim 12, further comprising
permitting authorized users to alter the workflow process definition on the fly while the process is being executed.

17. The method of claim 16, further comprising
pre-designating users who are authorized to alter a workflow process definition.

18. An electronic business process workflow method, comprising
providing in a computer system for an enterprise a class of pre-defined workflow processes that can be executed at runtime but are not alterable at runtime; and
providing on the same computer system for the same enterprise the capability of another class of dynamic workflow processes that can be created as a process definition at runtime, executed and altered at runtime by authorized users while the dynamic workflow process is undergoing execution.

19. The method of claim 18, wherein providing the capability of another class of dynamic workflow processes includes pre-designating users who are authorized to alter a dynamic workflow process definition.

20. The method of claim 18, wherein providing the capability of another class of dynamic workflow processes includes presenting to an authorized user a graphical user interface for composing or altering the workflow process definition.

21. The method of claim 20, wherein providing the capability of another class of dynamic workflow processes further includes pre-designating users who are authorized to alter a dynamic workflow process definition.

22. The method of claim 20, wherein providing the capability of another class of dynamic workflow processes further includes interpreting the dynamic workflow process definition at runtime with a meta-process.

23. The method of claim 22 wherein said meta-process is capable of handling arbitrarily nested combinations of sequential and parallel steps or blocks of steps.

24. A dynamic electronic business process workflow system, comprising
a workflow process graphical user interface for allowing authorized users to create and alter during runtime a workflow process definition; and
a meta-process for interpreting said definition during runtime to execute the corresponding workflow process.

25. The system of claim 24, wherein said graphical user interface includes a tree in which nodes correspond to respective process steps in the process definition.

26. The system of claim 25, wherein a node preceding the beginning of a block of parallel branches of steps corresponds to the block as a whole.

27. The system of claim 26, wherein nodes for sequential and parallel steps have distinct icons.

28. The system of claim 27, wherein parallel steps of said three types are all represented by the same icon.

29. The system of claim 28, wherein each node of the tree representing a step has associated with it multiple fields displaying respectively at least the agent and the action associated with the step corresponding to the node.

30. The system of claim 24, wherein said meta-process includes mutually recursive procedures for executing branch and step workflow processes.
